(19) United States
(12) Patent Application Publication
(10) Pub. No.: US 2023/0087930 A1
(43) Pub. Date: Mar. 23, 2023

(54) Telecom Provider Analysis Tool

(71) Applicant: Tangoe US, Inc., Indianapolis, IN (US)

(72) Inventors: Joan Schrenkel, Westfield, IN (US); Jaan Leemet, Aventura, FL (US)

(21) Appl. No.: 17/480,439

(22) Filed: Sep. 21, 2021

(51) Int. Cl. G06Q 30/02; G06Q 30/00; G06Q 20/14; H04W 24/02

(52) U.S. Cl. CPC G06Q 30/0204; G06Q 30/016; G06Q 20/145; H04W 24/02; G06Q 40/12

(57) ABSTRACT

A system and method incorporating Robotic Processing Automation and Machine Leaning to match telecom plans and features to the historical and predicted usage models of user devices associated with a company in order to provide a set of plans and features across one or more carriers that best fits the particular needs of the company.

### FIELD OF THE INVENTION

The present invention relates to a system and method for projecting telecommunications usage and automatically optimizing plans to minimize costs through mapping actual usage to available services from multiple carriers.

### BACKGROUND OF THE INVENTION

Telecommunications costs make up a large percentage of IT expenses for companies. This is especially true for technology-based companies where IT costs can, in some instances, reach as large as 5% of revenues or more.

Much of the technology used today relies on connectivity and interconnectivity between devices and systems via mobile telecommunications networks. Whether it be to access data, upload or transfer data, or communication between people, there is an ever-growing number of devices connecting to the internet requiring telecommunications plans and services. In fact, the use of mobile computing in connection with the work performed by employees has become standard practice, especially in view of the changed working environment precipitated by the covid-19 pandemic with more people working from remote locations.

Plans from telecommunications providers typically include at a minimum voice, data and SMS allocations. There are additional features that can be optionally added for roaming, international calling, voice mail, call forwarding and so on. The cost of these plans may vary based on usage. In other words, there is set number of voice minutes, data bytes, and SMS messages per given cycle. Plans may be pooled across users, using a shared amount of these services, and special categories such as in and out of network services may impact the cost. In the private consumer market, plans are often non-negotiated and fixed. However, for business customers with large numbers of devices, these plans are often customizable, and prices may be negotiated.

So, when selecting telecommunications providers, pricing and service have become the fundamental factors in a company's decision making. While in the past, coverage was an important factor, to a large extent all the major players now have similar ubiquitous network coverage along with a roaming partner network extending this coverage globally.

Similarly, while for many years there was a competitive play in terms of network performance factors such as reliability, speed, or qualities such voice clarity, advances in widely available technology and availability of networking equipment have leveled the field. As a result, network performance is generally more than adequate from virtually all providers today. Telecommunications services are really becoming commodities with pricing being the driving factor when competing for new subscribers.

Determining optimal telecom plans for a company is a complex exercise of looking at existing needs and projecting future needs. Usage dynamics across companies, even in the same industries can vary considerably. Take for example a large services company which has a mobile workforce completing workorders in the field. The workforce primarily comprises technicians with some back-office support staff who spend much of their time on the road filling out reports in a mobile app at the conclusion of each job. The mix of devices, data, voice, and SMS usage would be relatively low for such a company. However, for another company made up primarily of marketing consultants, the workforce may comprise a mix of creative people who use design tools to build and share presentations, often using multi-media. This workforce would potentially need a large bandwidth to develop and share these products. Likewise, an international sales force would require roaming features and packages and increased voice minutes. Still another company may spend a large portion of their time in mobile video conferences requiring little in terms of roaming or voice requirements but would require a large amount of data.

These are only a few examples, and the reality is that almost every company has a unique mix of telecom needs. To further complicate matters, telecom needs for a company rarely remain constant. As new tools are introduced, as companies adjust to fluid business dynamics, or as new managers come in and introduce new processes and procedures, usage patterns in a company can dramatically change.

The challenge many companies face is determining which telecom provider will give them the best price and have packages to meet their unique and dynamic telecom needs. Keeping up with a company's dynamically changing telecom requirements and then matching these needs to an optimal plan or set of plans is a complex exercise that to date has not been effectively achieved. Additionally, telecom services are often critical to a company's operation and rarely analyzed in detail except by consultants. While optimization may be performed in an ad hoc manner, no system has provided the ability to look across multiple carriers and match a company's telecom needs to multiple carrier telecom offerings dynamically.

Carriers have tried to adapt to evolution in the telecom industry by providing a variety of plan options, which are often crafted to meet the needs of large enterprises. However, these plans generally follow general trends in the industry and are often not tailored to the specific needs of a company.

U.S. Pat. No. 10,873,670 is directed to a system that runs monthly before the billing date to optimize plan usage within a set of available plans from a carrier. However, while this system is a large step forward in the industry, the system is focused on analyzing plans of the current carrier as opposed to expansively looking at multiple different carriers. A challenge of looking at multiple different carriers is the difficulty in correlating plans or options offered from different carriers in a comparable fashion. For example, features in one plan may be referred to differently. The plan structure may include various features not offered in plans of different carriers so multiple plans may be needed to be compared to one plan of the first carrier. Additionally, data formatting is not consistent throughout the industry, which can present a challenge to automated systems when comparing terminology.

Another reference, U.S. Pat. No. 10,243,973 discloses a system and method for matching cloud hosting platforms to applications based on resource usage and billing models. However, this system does not consider voice/SMS/data usage and international or local costs and features. Rather, this reference focuses more on processor and bandwidth use on a hosting server as opposed to analyzing mobile telecom services provided by a plurality of different carriers to dynamically provide adjustment(s) in service plans.

With telephone number portability, and month to month plans generally available, it is increasingly desirable to have the ability to switch carriers dynamically. This is increasingly feasible without negatively impacting service and being bogged down with negotiations relating to lengthy contracts and penalties or disruptions.

When considering plans encompassing thousands of users, potential savings can add up quickly. The key is speed in making an analysis and adjustment of the dynamically changing working environment and predicted usage.

It would thus be beneficial to have a system that could automatically map the current usage and prior usage of a company/account to multiple carrier offerings to determine projected cost savings in a dynamic way. It would also be beneficial for the system to automatically perform forensic analysis as described above to determine actual cost savings by billing period, which could be compared, for example, to previously generated projected cost savings.

It would further be beneficial to have a system that could map across multiple different telecom carriers to determine if moving a subset of users to a different plan or different carrier would result in cost savings based on the subset's actual usage.

It would also be beneficial to have a system determine an optimal plan(s) for the users for which the system automatically generates a request for such plan(s) that is set to a carrier(s).

### SUMMARY OF THE INVENTION

Therefore, it would be desirable to provide a system and a method of dynamically mapping current usage of all individual users on a plan to one or more carrier plans to evaluate the fit and cost of a carrier's plans, including pooled plans and applicable features, to meet a company's needs.

It is further desired to provide a system and method to dynamically discover the plans as they are made available through RPA (robotic process automation) bots and ETL (Extract Transform Load) components that will re-run the calculations based on currently available plans in real time.

It is still further desired to provide a system and method to individually analyze all users and dynamically determine if allocating individual users into specific user groups spread across multiple different telecom carriers would provide a more cost-effective solution for the company.

It is also desired to provide a system that maps actual usage and generates an ideal plan(s) based on the mapped actual usage and automatically generates a request for the ideal plan(s) that is provided for multiple different telecom carriers to bid on. For instance, such an ideal plan(s) could be posted to a virtual telecom marketplace accessible by multiple different telecom carriers.

In one embodiment, the system is provided access to usage statistics from itemized billing provided by the telecom carrier or from a telecom expense management system. This data at a minimum, includes monthly (billing interval) based amounts of data, voice and SMS usage (i.e., both local and international usage). It is contemplated that this information may be provided in real time or near real time allowing the system to operate with high granularity providing recommendations during a current billing cycle. This would include recognizing not just billing cycle usage (i.e., monthly usage and patterns), but also weekly, daily, or even more granular usage information. This greatly increased data granularity allows for greater accuracy in formulating a dynamic plan(s) needed by the company and provided to multiple different carriers.

While carriers often allow changing plans in-month for devices within a company's repertory, removing devices and moving these to another carrier may entail additional expenses and constraints. In other cases, contract terms may have been set with fees to break or reduce subscribers from the plan within contract dates. These costs would be factored into the predicted overall cost of changing to a new provider and the algorithm can also predict a future date upon which at which it would be more economical to move.

The RPA and ETL components in essence, find the plans that are available (including pooled plans) and converts these into data the system can utilize and can be mapped. The system then extrapolates predicted usage and maps that data to a given set of plans across multi-carrier models considering any costs of migrating across carriers.

When establishing optimal plans, the factoring in of pooled plans is also made based on the eligibility of the available plans for pooling and how savings are affected. Plans may be read from service provider sites which are publicly available and advertised directly, or they may be entered manually to match offerings specific to a company from the carriers.

While intuitively an ideal plan may seem like it simply matches the total use of data, voice and SMS, this is not the case under most circumstances. In the example of a few users that do video conferencing and travel internationally, adding a roaming feature to all users in the pool would most likely be more expensive than only adding it to the few that travel. Similarly, dividing the overall usage across the board to include the large users may push the whole group into a higher category.

Accordingly, it is more likely that one would get better pricing separating out users with more intense data, voice and SMS usage. A similar strategy is used across components that may add cost to a plan. For example, relatively large, medium and small SMS users, as well as those using roaming or other paid features may be separated out and analyzed. The billing categories are often derived using step sizes, example data may go up in price with a 1 GB step size. Part of this classification of users into the available step sizes would include moving all users that are under 1 GB into one class.

Further, if there were 100 users that were all under 1 GB and the resultant aggregate usage was very much under the total allocation (e.g., using only 50 GB of the resultant 100 GB allocation), it would be desirable to add larger users into this pool to take advantage of the unused allowable data in this group that is unused. Even with a smaller unused data margin potentially two 20 GB users could be migrated into this group or pool of users expanding the group to 102 users but only utilizing 90 GB of total data.

In some cases, the carrier may not offer a particular size data class (e.g., 3 GB). A jump to the carriers next data group of 5 GB may add too much cost. In this case, it would be desirable to ask the carrier to make a custom 3 GB plan for the customer to save costs. In many cases carriers can offer such custom plans and with the analysis done in advance and knowing what would work and would potentially save money, negotiations are greatly simplified and the carrier can just verify whether or not they can do it (or offer competitive plan pricing on the 5 GB plan if they cannot).

One goal of the invention is to provide those in charge of optimizing telecom expenses with a clear-cut recommendation of which plans across carriers are ideal, and a trigger to make changed. It can be run at contract renewal time or regularly within the billing cycles. Another goal is to facilitate the RPA to run standalone and autonomously make changes to provisioning on its own to capture the greatest savings based on measured and projected usage within a billing cycle.

The system is intended to run as one or more RPA bot(s) and ETL components autonomously in the background to discover carrier plans and features. Additional RPA bot or bots run mapping of prior usage and project current month usage to propose or implement plan changes dynamically adjusting the allocated plans as needed to optimize cost.

What is desired then is a system and method to identify plans using RPA robotic processing and ETL components and to map these plans to existing and predicted usage profiles creating combinations across carriers, users, plans and features to optimize costs for the system. Additionally, it is desirable for the system to propose optimal plans that match existing and projected usage patterns. These optimal plans could be proposed to carriers as part of a Request for Proposal (RFP) that outlines predicted costs and allows carriers to provide customized plans at optimal cost.

For this application the following terms and definitions shall apply:

The terms “user” or “users” mean a person or persons, respectively, who access services providing voice, data, SMS, apps or any type of programs in any manner, whether alone or in one or more groups, whether in the same or various places, and whether at the same time or at various different times.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

In one configuration a telecom optimization tool is provided comprising: a computer having a storage and connected to a network, and a software application executing on the computer, the software application in communication with a plurality of user devices coupled to a mobile device network and measuring voice, data and SMS usage for each user device. The software application saves the measured voice, data and SMS usage for each user device on the storage to generate historical usage data for each user device, and the software application monitors apps that are accessed and installed on each user device and generates app data that is saved on the storage. The software application further monitors app usage on each mobile device and generates app usage data that is saved on the storage, and the software application predicts future voice, data and SMS usage for each mobile device based on the historical usage data, the app data and the app usage data. The software application still further comprises a Robotic Process Automation (RPA) bot in communication with a plurality of telecom provider computers, the RPA bot obtains telecom plan data relating to telecom plans offered by the plurality of telecom providers. Additionally, the software application analyzes the gathered telecom plan data and automatically adjusts a telecom plan associated with at least one of the user devices based on the predicted voice, data and SMS usage for the at least one user device.

In another configuration, a telecom optimization tool is provided comprising: a computer having a storage and connected to a network, and a software application executing on the computer, the software application in communication with a plurality of user devices coupled to a mobile device network and measuring voice, data and SMS usage for each user device. The software application saves the measured voice, data and SMS usage for each user device on the storage to generate historical usage data for each user device, and the software application monitors apps that are accessed and installed on each user device and generating app data that is saved on the storage. The software application further monitors app usage on each mobile device and generates app usage data that is saved on the storage, and the software application predicts future voice, data and SMS usage for each mobile device based on the historical usage data, the app data and the app usage data. The software application still further generates an RFP based on the predicted future voice, data and SMS usage for each mobile device, the RFP automatically posted to an online marketplace by the software application where the online marketplace is accessible by a plurality of telecom provider computers. Additionally, the software application receives telecom plan data relating to telecom plans offered by the plurality of telecom providers in response to the RFP, and the software application analyzes the gathered telecom plan data and automatically adjusts at least one telecom plan associated with the plurality of user devices based on the received telecom plan data.

Other objects of the invention and its features and advantages will become more apparent from consideration of the following drawings and accompanying detailed description.

### BRIEF DESCRIPTION OF THE DRAWINGS

FIG. 1 is a block diagram of the telecom optimization tool according to one configuration of the system.

FIG. 2 is a block diagram of the telecom optimization tool according to FIG. 1.

FIG. 3 is a functional diagram illustrating the RPA process of analyzing and mapping usage to plans available from different carriers according to FIG. 1.

FIG. 4 is a flow diagram illustrating one configuration of the RPA logic in analyzing plan selection according to FIG. 1.

FIG. 5 is a flow diagram illustrating one configuration of the RPA logic in plan extrapolation.

FIG. 6 is a flow diagram illustrating one configuration of RPA logic in pool plan determination.

FIG. 7 is a flow diagram illustrating one configuration of RPA logic in creating an RFP plan proposal.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

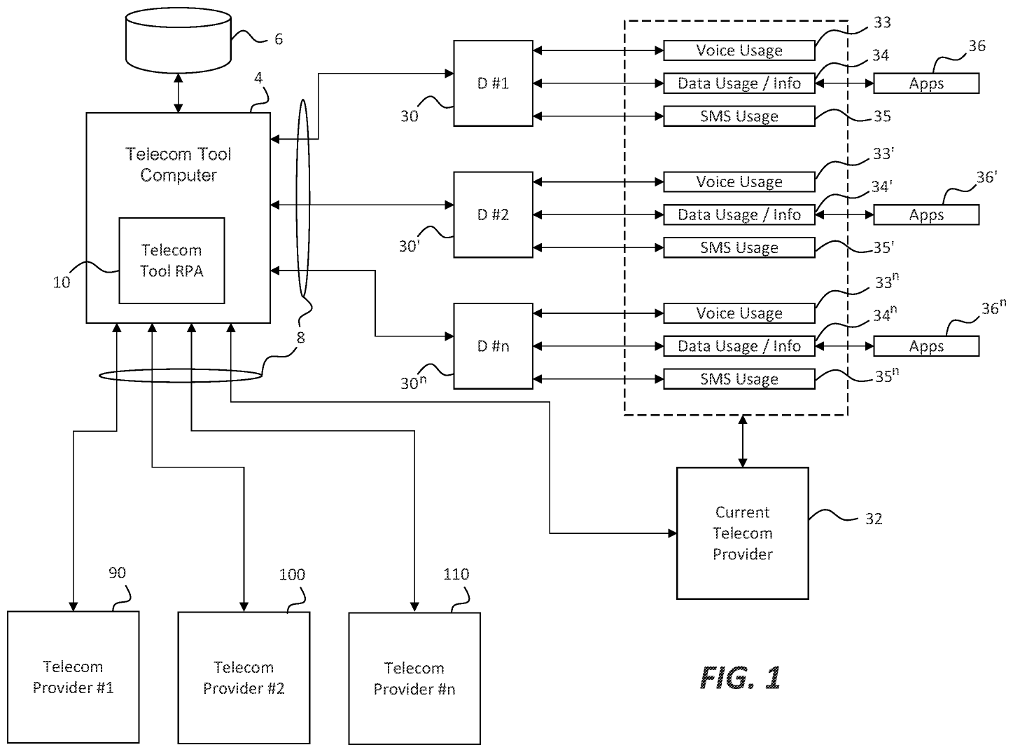

FIG. 1 shows one configuration of the telecom optimization tool including a computer 4 having a storage 6 that is coupled to a network connection 8. A software application 10 is provided that executes on computer 4.

Also shown in FIG. 1 are devices 30, 30′, 30n which may comprise a user device such as a mobile phone. Devices 30, 30′, 30n are coupled to computer 4 via the network connection 8.

Computer 4 is also connected to telecom provider computers 90, 100, 110 via the network connection 8. It is contemplated that the telecom provider computers 90, 100, 110 are associated with different telecom providers that offer different telecom plans. Also shown is current telecom provider computer 32 that is coupled to computer 4 via the network connection 8. The current telecom provider computer 32 is illustrated having access to monitor the usage of devices 30, 30′, 30n for which the current telecom provider provides voice, data and SMS services. For example, device 30 utilizes voice 33, data 34, and SMS 35 that is monitored by the current telecom provider. Also monitored are the apps 36 that are installed on the device 30. The monitoring of apps 36 may be done by computer 4. All of the monitored voice 33, data 34, and SMS 35 usage information is gathered by computer 4 and saved on storage 6. Likewise, the apps 36 information relating to the apps installed on and used on device 30 is also gathered by computer 4 and saved on storage 6. All this information relating to actual usage of voice, data, SMS and apps is used by software application 10 to predict future usage by device 30.

It will be understood that device 30′ and device 30n are similarly monitored so that predictions can be made for each device based on actual data gathered from the device. Predictions can further include data relating to the apps installed on the device. For example, if a video conferencing app is installed on device 30, the software application 10 can used historical usage data from third party devices to extrapolate an estimated usage of the app. In this case, the use of video conferencing would increase the data consumption of device 30, but would expect a decrease in the voice requirements for device 30. This data from third party devices could be gathered from devices on the same service plan, or device used by workers in the same work unit and the user of device 30 or could be from other sources.

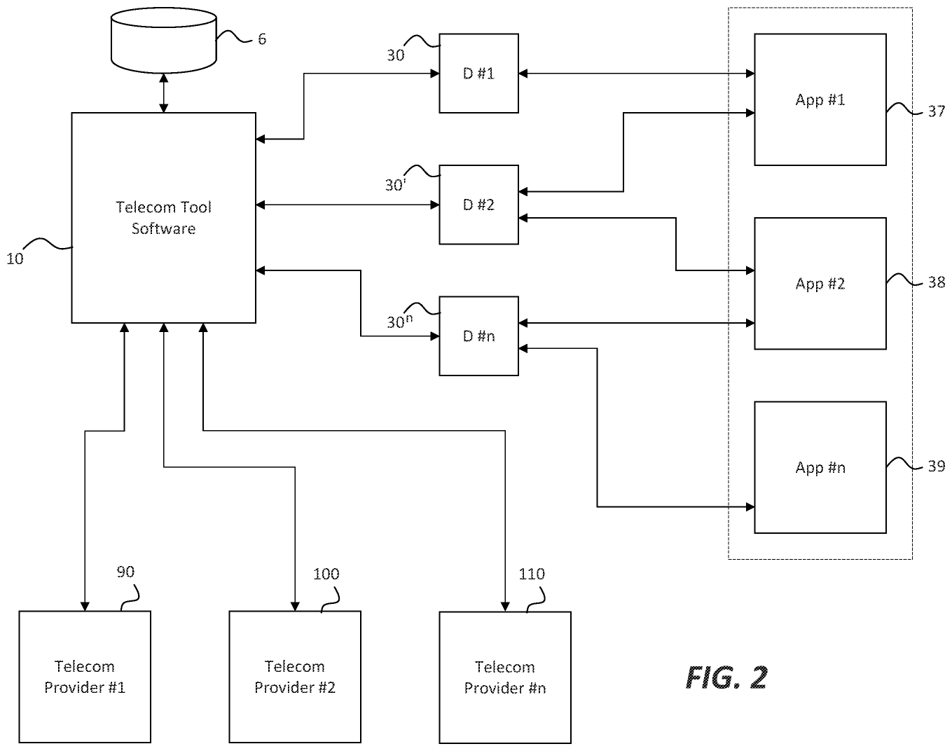

FIG. 2 illustrates the devices 30, 30′, 30n that may have downloaded and connected with resources associated with apps 37, 38, 39. For example, certain devices may have downloaded and installed certain apps with other devices have installed and downloaded other apps. The software application 10 monitors what apps have been downloaded and accessed by the devices 30, 30′, 30n so that individual usage and group usage may be monitored. It is contemplated that as apps are adopted and used by devices 30, 30′, 30n, the individual voice, data, SMS usage may change, however the overall distribution may change little. Alternatively, as new business methods are adopted, it could be that the voice, data, SMS requirements for an entire business unit(s) may dramatically change. The ability for the system to automatically monitor, predict and modify plans for a group(s) of devices 30, 30′, 30n is critical to avoid very large charges at the end of the billing cycle. Based on the live data fed into software application 10, the telecom tool can dynamically predict changed usage and automatically make adjustments to fit the changing needs of the business unit.

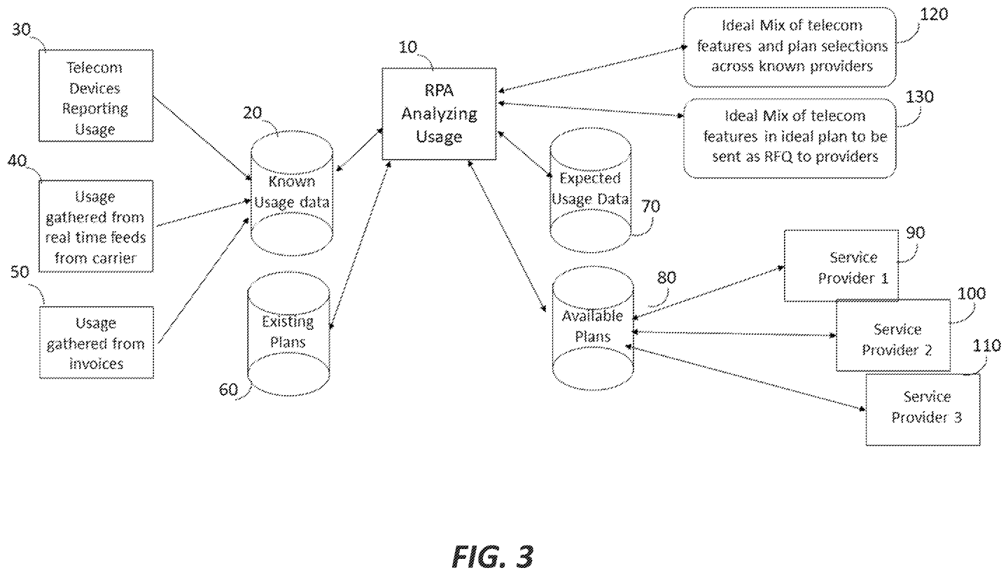

Turning now to FIG. 3, it is contemplated that the software application 10 may comprise a Robotic Process Automation (RPA) bot that is able to dynamically communicate with telecom provider computers 90, 100, 110. The RPA system 10 analyzes usage as discussed above. The RPA system 10 reads known usage data 20 from a database or storage area to gather historical usage of the devices. The data gathered from the devices can be accomplished through embedded usage apps or monitoring apps that capture usage statistics directly from the device. In some cases, these can also be monitoring applications which are put in line with the device as traffic is routed through a common path which can measure and monitor data usage.

The usage data can also be gathered from real time or near real time feeds 40 from the service providers or carriers. This may be through a company specific portal whereby the system can obtain usage from the service provider about in-month usage as well as historical usage for prior invoicing periods. Integration with such systems can be through web scraping apps or via an API to the carrier system.

Telecom usage can also be gathered directly from invoicing data 50 that may be manually or automatically scanned by the system, entered, or analyzed if entered in electronic form. Regardless of how data is gathered 30, 40, 50 the known usage data 20 represents an accurate depiction of historical usage for the device being monitored across all billable categories such as data, voice, SMS for both domestic and international so that cost estimations can be made when mapped to a service providers billing model.

The RPA system 10 also gathers information about existing plans 60, which are currently active for the company running the RPA system 10 and for the devices in question. It should be noted that these existing plans 60 may no longer be active on the service provider system and may be customized plans or grandfathered plans for which the company has subscribed in the past and the service provider is continuing to provide support for.

Using the known usage data 20 the RPA system 10 extrapolates patterns of usage and predicts usage for upcoming billing periods (months and years) in an expected usage data 70 area. For example, if a device's known usage data 20 shows a historical use of 3 GB/month with a 10% variance, but that this usage has been trending upwards over the past few billing periods, the RPA system 10 extrapolates the usage over the next 12 billing periods and predicts usage based on the pattern of increase and on previous extrapolations (e.g., know data for other devices where installation of an app increases data usage drastically in the first few billing periods but levels out in the following billing periods). The system can also look at seasonal trends and changes such as end of month, end of quarter, summer or winter seasonal variances and factor these into the calculation. The formulas are complex and include machine learning from the patterns of this device and other devices at the same company (and even trend analysis and benchmarking from other companies with similar characteristics such as being in the same industry, same geography, having similar demographics etc.)

The analysis and prediction of these patterns forms the basis of the mapping of the expected usage data 70, which is done for all devices in the group and/or company.

The RPA system 10 also captures the available plans from all sanctioned and configured service providers 90, 100, 110 and includes its knowledge of existing plans 60. This allows the RPA system 10 to determine if staying on the same plan 60 or moving to a new plan or set of plans from other telecom providers 90, 100, 110 is most beneficial for the group and/or company.

It should be noted that the plans available from the carriers may not necessarily be the published and publicly available plans. Rather, companies may request quotes from carriers for plans and negotiate the best offerings before running the RPA system 10. If for example, a discount is applied due to many devices the company must support, or some services are given for free, these are included in the plan descriptions and factor into the calculations.

The analysis and mapping are accomplished by taking the expected usage data 70 for each device, which was derived from the known usage data 20 and then mapping that to available plans 80 and existing plans 60. Factors such as any contractual cost penalties or fees for moving to a different carrier are also factored into the calculation whether these be by-line or in aggregate. A cost analysis is done, and the most economical plan set is proposed 120 as a grouping of plan selections across the existing plans 60 and available plans 80.

In some cases, plans from the existing plans 60 and available plans 80 that are proposed 120 may not be ideal. Knowing that they may lose the business, service providers may offer additional incentives or lower prices. In such cases, the RPA system 10 can re-run to analyze the available plans 80 again taking into effect the new offerings from the service providers 90, 100, 110. Alternatively, and to help with this process the RPA system 10 also determines the ideal usage composition in terms of services and features 130, which can be sent as an RFP to the various service providers.

For example, if the RPA system 10 determines that the expected usage 70 will be X terabytes of data, Y minutes of voice data, and Z SMS messages (split between domestic and international) is expected with a probability of overage factored into the equation based on known historical usage 20, the service providers are invited to creatively address the expected usage offering both improved pricing and other incentives to win the business. This is a win-win as the expected usage data 70 needs will be met, and there may be additional incentives or features included. Additional features may include more frequent upgrading of devices, availability of other plans like voice mails, call forwarding, mobile to mobile calling in the pool etc. The RPA system 10 may have some or all the usage statistics of these features in the known usage data 20 and may be able to assess the benefit of these additional features, even if they do not entail additional monetary amounts in the monthly billing.

For example, if the average employee changes their device every 2 years, either through loss, breakage, or simply wanting to upgrade, having a free replacement or upgrade after three years would not be ideal and would incur some cost for broken or stolen devices. Alternatively, a proposal offering a yearly upgrade would be beneficial and could factor in these device replacement costs. These costs can also be offset by calculating insurance additions whether with the carrier or externally.

As another example, if service times with one operator and customer satisfaction as much better than with another, these can be factored into a comparison. Other features such as unlimited voice mail messages may or may not be valuable depending on the usage characteristics of the devices 20. Each feature or incentive offered can be weighed in making the determination, but the RPA system 10 will primarily help to offer the cost-based knowledge to the operator so that such a decision can be made.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

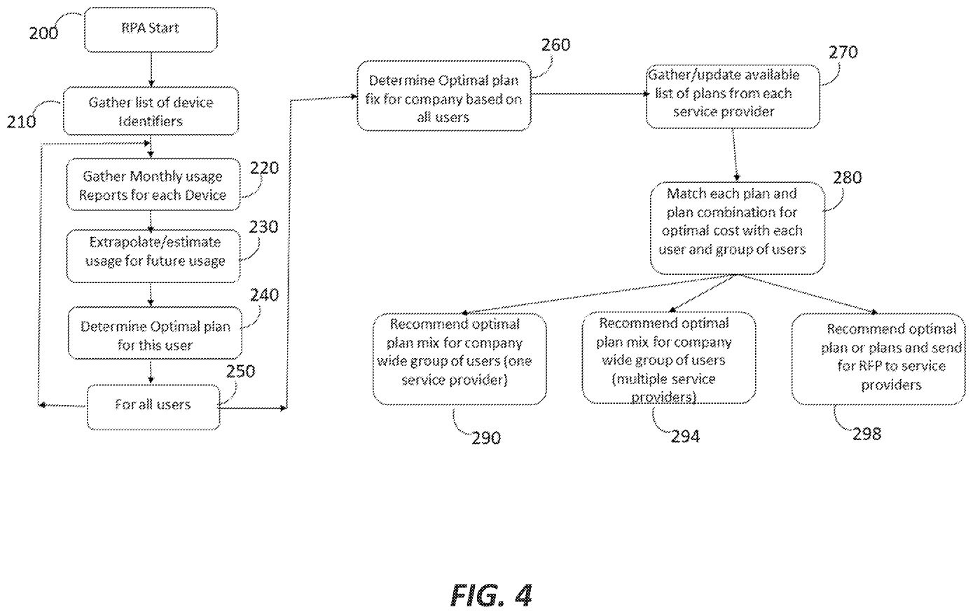

Turning now to FIG. 4, the RPA logic used in analyzing the plan selection is illustrated. The RPA 200 gathers a list of devices 210 from an inventory list or other input list describing which devices are currently in use and paid for by the company. In some cases, people use personal devices, and the company may pay a stipend for the plans. In such cases, these devices are generally not included in the calculation, although the ultimate plan proposed by the system may be offered to such employees once the calculation is complete.

The list of known and applicable devices 210 is cycled through gathering monthly usage data 220 from prior months. This analysis can go back as far as necessary based on available data to form a basis to predict usage patterns. If devices have been in service for many years, the last 2 years are typically used. Due to the rapid changes in any business environment, going past 2 years is usually not relevant to future calculations. In cases where less data is available, such as when new employees have started for example, data from peer groups is used to extrapolate the known data by combining trends and patterns with these peer groups. These include but are not limited to the department whether the employee works, their role, their demographics.

Whether based on actual historical data 220 from the device itself or estimated data combined with peer groups, the RPA makes an estimation of usage for upcoming periods 230 predicting future usage. Based on the estimation, the usage is mapped to an optimal plan 240 which maps exactly to the usage characteristics determined. This is what the expected usage would be for the device and this a plan that matches exactly is made (whether or not such a plan actually exists). Note that some margin is factored in to compensate for any expensive overage costs. For example, typical plans allow a maximum amount of usage and then increase costs substantially for overages. If it is determined for example that a given user is expected to use 1 GB of data, a variance factor can be added to increase this to 1.1 GB. The size of the variance factor is determined by the company and often based on the availability of tools to monitor and adjust usage in a given month to avoid costly overages. Companies with such services may employ a smaller margin. This process is repeated for all users 250.

The all the optimal plans are determined 260 for all users, the RPA will also gather the available list of plans from each service provider 270. As mentioned, this may be both publicly available plans as well as custom plans proposed to the company by the service provider which has been entered in a format from which the RPA can recognize the services and the costs.

The RPA will then employ machine learning algorithms to traverse the list of ideal plans 26 and available plans 270 through a process of matching 280. This matching process 280 also included complex calculations such as pooling, for carrier plans which offer such services. Pooling involves sharing a pool of services, for example Gigabytes of data, between a group of users. By using pooling, we can smooth out month to month variances in usage between a group of users and provide a shared data pool which will remain more consistent even if individual users may go up and down in their usage patterns in each billing period. Not all plans are available for pooling.

This matching process is the core of what the RPA will do as an iterative brute force method is not possible even with extensive computing capability due to the large number of combinations when devices are in the thousands or 10s or 100s of thousands. The machine learning algorithms employ logic that groups users based on common characteristics, forming pools or groups of voice heavy users, data hungry users etc. The algorithms also extract outliers such as the heaviest data users, excluding these from pools and putting them onto more expensive individual plans while keeping overall pool costs low.

In one example of how data can be extrapolated, the usage data is extrapolated from both past behavior and through predictive analytics and machine learned behavior from both other users as well as other companies. This is more than simply looking at how voice/data/SMS or even roaming change over time. The system does include this data, but also utilizes machine learning to predict future usage more accurately. The RPA system 10 will make these predictions automatically to change the plans/carriers without the need for human intervention. Some of the techniques employed include:

Identification of a pattern of data use. For example, the downloading and usage (or discontinuation of use) of a particular app in a group of users from the same/similar departments, allows for prediction analytics to analyze how changes in data usage will evolve as users begin to use (discontinue) the app in their day to day. By learning how other users have done this, by knowing the usage patterns of the app, the system can extrapolate this use onto new users of the app.

Mapping the interrelationships between data/voice/SMS. For example, as data increases through a particular app (such as, WhatsApp, or Skype, or Teams) the system will extrapolate a reduction in traditional SMS messaging as users adopt other messaging programs. As video calling increases, a reduction in traditional voice usage is extrapolated.

Detection of connections to Wi-Fi. For example, a user may regularly log into onto Wi-Fi network such that the system recognizes that the user has added a Wi-Fi connection visited often. The system can then extrapolate a reduction in mobile data usage.

When complete, output from the RPA includes a set of plans from a given service provider 290 that can be used to negotiate a better price from a single service provider. An optimal plan mix across multiple service providers 294 using the best services from each. For example, if one service provider has the best offerings for voice services, heavy voice users may be moved into this category. Heavy data users or texting users may go into another category and moved to a different provider.

In addition, a recommended set of optimal plans is created 298 Which can be sent to service providers for an RFP. This may be a simple grouping of a pool of users with a set of outliers, but it may also separate categories of users such as heavy voice users and heavy data users into separate camps. The machine learning algorithm has knowledge about how service providers have formulated their plans and have adapted in the past and takes this into account when making the ideal plan formulation.

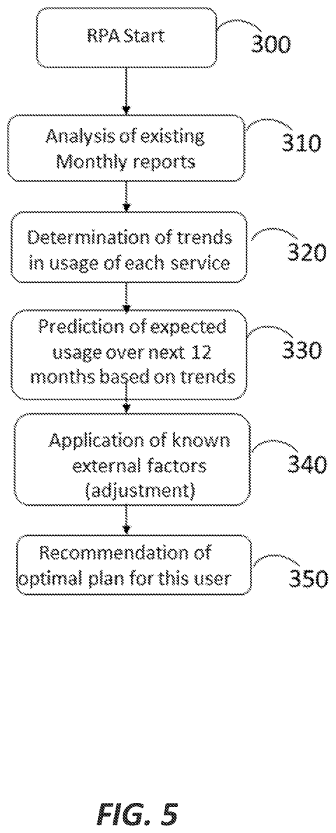

Turning now to FIG. 5 we see the RPA logic in plan extrapolation in how predictions are made in more detail. The RPA starts 300 and proceeds to analyze the monthly usage reports 310 gathered from historical billing, historical data usage from devices, and historical feeds as depicted in FIG. 3 30, 40, 50.

The usage is analyzed 310 and trended by each category of service. For example, the number of voice minutes and classification of voice usage over the possible costing models such as international voice, mobile to mobile voice, mobile to land-line voice, etc. This applies to voice, data, and SMS billing. Data billing can have characteristics for billing such as data from a common source such as the company servers which may have sponsored billing (i.e., it does not apply to the plan and is counted outside of normal billing). It may also have time-based variable such as usage during office hours, peak times, after hours and weekends. It may also have application specific costing parameters such as social media apps or emails or video and audio streaming apps. The granularity of data captured will be based on the most granular data models being used to cost out available plans. Even if one service provider offers discounted billing based upon one or more of these parameters, the data is broken up to the most granular level and then recombined for costing analysis for those plans that do not offer these separately costed services.

The usage in each of the categories is analyzed to establish trends and patterns 320. Simple patterns such as a slowly growing amount of data month to month or year to year are employed as well as more time-based patterns such as increases in usage on Fridays, weekends or even at end of month periods or end of quarter periods as is common for sales organization. The patterns are also matched over multiple devices and users in the same organization to determine trends. As in many market studies, we find early adopters that may embrace new methods and new technologies in company departments that reveal trend lines before most users come on board. For example, the use of new messaging tools to replace traditional voice calls, mobile to mobile OTT messaging apps to replace traditional SMS messages, etc. As the system looks at individual users and detects that a small group are shifting usage in each direction it applies machine learning and predictive analysis to help establish these trends. Similarly, external companies with obfuscated data are used to benchmark trending in similar industries and geographies. This data is used to form accurate models for future consumption.

The modeled data is then used to provide a prediction for the next 12 billing cycles 330, which forms the basis for plan selection or ideal plan determination. External factors 340 are also fed into the model to compensate for any expected or known changes. For example, if a company knows that they will be moving to a new video-based training service, a manual input of the expected increases in data traffic and who may be affected can be entered. Similarly, when a company participates in sales conferences or other events that involve travel, the number of people and dates of such events can be incorporated into the model for calculations. For many companies, these are recurring events that happen yearly, and the model can be tweaked from time to time to adjust for new shows or changes in venue or discontinued shows.

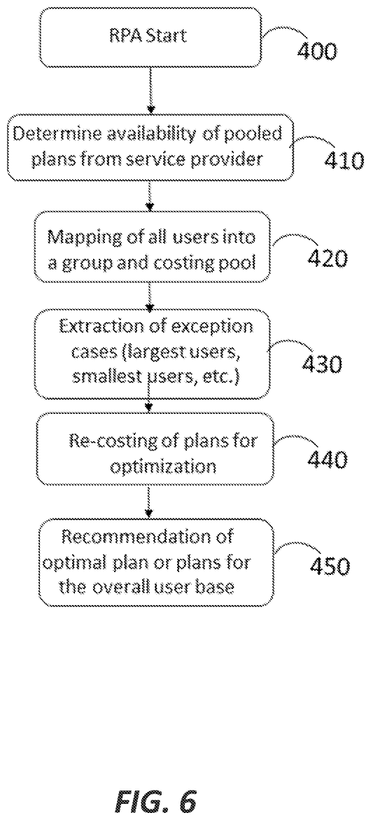

Turning now to FIG. 6, the RPA logic used for pool plan determination is illustrated in more detail. The RPA starts 400 by determining the availability of plans 410 from a given service provider that are eligible for pooling. Some plans, an obvious example being unlimited plans, are not eligible even if they are offered to individual subscribers. There are many reasons why certain plans are not offered for pooling, but the reasons are irrelevant here as only those plans offered for polling for whatever reason are used in factoring in polling to the optimal plan selection.

Users across the company are mapped into costing pools based on the usage patterns that they exhibit in the optimal plans (as determined in FIG. 5 350). In one example, the data that expected to used may be added up along with a buffer amount of approximately 5%, after which the system may check for pricing on a pool of that amount of data. It should be noted that when pooling, the buffer amount can be reduced considerably from the buffer employed for individual plans as most costing models will charge fees for overages but will not give credits for under-use. In the rare case, under-use may be moved to the next month but there is rarely a cost benefit, simply a reduced risk of overage cost in the following month.

When modeling, the system again uses machine learning and predictive analysis from prior models to make its selections on what to tweak and where. It is impractical to run through all possibilities by brute force when so many options exist for so many users. In a simple example, imagine 4 plans being offered with 3 options each for voice, data, and SMS amounts. Add to this international roaming features, specific data applications, times of usage, and even device types such as mobile land line for calling, and we quickly grow the number of possible combinations. Now consider a company with 50,000 lines, and then further add the possibility of forming pooled groups. You can see how the combinations by brute force grow exponentially beyond what can be computed, never mind done manually.

One technique employed is the extraction of the largest and smallest users 430. In this case, if we have a pool of users where the average data use is 1 GB, but we split the users over a curve and take out the smallest and largest ones we end up with a normalized user base that better represents the average users at the company. Given 100 users, we may find 1 or 2 that use 10× the data of the average user, we may find 1 or 2 that use no data at all. In such extreme cases, the system uses algorithms such as mapping out all users with (a) no data, (b) all users with data <the smallest plan available, say 100 mb (c) all users with data exceeding the second to largest plan. In these cases, it is not a fixed percentage or fixed number but rather logic that can be used to map these users into lower cost plans is employed to make the determination as to which users to exclude.

Once the smallest and largest users are removed, the re-costing 44 of plans is made from the original cost estimate of all users in the same large pool. In this case, if we consider that of the example 100 users using 1 GB on average (making a total pool of 100 GB), we now extracted the 2 largest users that used 10 GB each. We are now costing a plan for 98 users that is based on 80 GB and two 10 GB or unlimited individual plans.

The calculations are redone by extending the limits of which users are removed or added to the pool to determine the optimal cost. For example, we may find that removing two more users that averaged 5 GB of usage, now making a pool of 96 users using a total of 70 GB makes for a better offer, even if we put these 4 users into larger individual plans. As such, we are not iteratively going through the impossible task of trying all combinations but rather using machine learning and historical knowledge along with the knowledge of billing models and plans that are available to move primarily edge cases in and out of pools.

In one configuration, the system maps to various plans as follows:

Carrier plans, regardless of carrier are mapped with two primary components across the various billed commodities Data, Voice, SMS, for both local and roaming. These components are a maximum allowed usage, and an overage charge. Looking at two plans there may be a 1 GB data plan for $10 with an overage charge of $10 per GB. The next plan up may be a 5 GB plan at a cost of $20 with an overage charge of $10 per GB. In such a case, the system will take the predicted usage of 3 GB and identify that the cost is $30 for the smaller plan ($10+$20 overage charge) versus $20 for the larger plan.

To make the comparison, a table is created which lists all the plans in rows along with the attributes for comparison and weighting for each attribute, but the primary decision factor is the cost of the plan (including any overage and fees) in making the selection. The mapping of predicted usage into each of the plans is made for multiple months/billing periods and the cost is calculated to determine if making a change should be implemented.

In some cases, the company or group may have outgrown a given carrier with its usage. As an example, a carrier offering 1 GB plans for $10, 3 GB plans for $20, and unlimited plans for $100. Once beyond 3 GB the company is forced into a much higher tier. If another carrier also has a 5 GB plan and 10 GB plan at lower costs, then a change of carriers is warranted.

Note that the columns and attributes in the plan comparison table can grow well beyond the traditional voice, data, SMS, and roaming cost. Carrier plans have become more competitive and features such as ‘free SMS on weekends or after hours or free calling between employees, or free Facebook at lunch time, (Facebook is just used as an example, and this can be Amazon, Twitter, or Salesforce and the like). This specialized data usage must all be accounted for and then matched with the predicted usage. If someone uses lots of data on Facebook at lunch time, the system will discount the predicted amount of data when adding up the cost on the carrier plan offering this feature versus the cost on the other carriers that do not offer free Facebook at lunch time as an example. As the complexity of the table grows to offer more esoteric features, the data that is gathered is adapted and/or formatted to be able accurately compare it. This is a challenge with automated comparisons as formatting and nomenclature from plan to plan may vary widely. Use of the table to properly format the data for comparison is important for dynamic adjustments.

This usage data provides valuable insights that carriers are not allowed to capture themselves for privacy reasons. However, with corporate devices the system can automatically capture this data from devices. Non-corporate-owned devices have limitations on the granularity of data that can be captured, but still provide a window into usage that can be used for comparison.

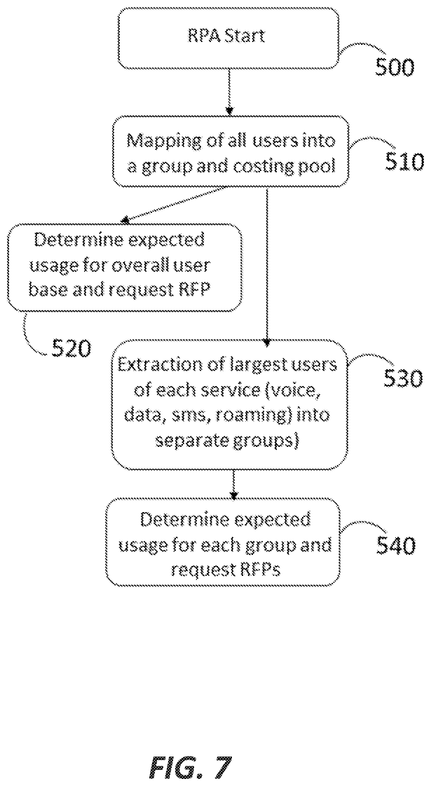

Turning now to FIG. 7 the RPA logic is used to create an ideal RPF plan proposal. Again, the RPA starts 500 and maps users in the ideal pools and plans as was done in FIG. 6 440, 450. In this case, the RPA can make an overall determination with all users and combining all data, voice, SMS and other options and services into a large group and simply request an RFP for this data 520. The RPA will also extract the largest and smallest users in each category 530 as well as grouping users together, such as those users that travel and require international roaming plans to form groups that can be costed and quoted separately. Each of these groups is sent to RFP 540 and can be bid on by separate service providers.

For example, looking again at an example of 100 users, we may find that only 5 are doing any international travel and when they do use about 1 GB of data use. We may find that a pool of 1 GB for these users makes sense and group them into an international roaming plan group. However, we may see that much of the data is used by a single person and separate them out into a separate plan on their own. Again, machine learning and historical success and predictive analytics are used to make the best choices before going to RFP.

The RPA maintains historical context in the data that led up to the decisions and them also monitors the resultant cost and success rate of the decisions made to improve its decision making for future changes.

The result is that on the typical billing cycle, the RPA can let an operator know that it expects moving some users or changing some plans will be effective in saving the company costs. These can be checked over by the operator, or the system can be set to automatically provision and change the plans with the carrier systems.

While the invention is susceptible to various modifications, and alternative forms, specific examples thereof have been shown in the drawings and are herein described in detail. Is should be understood however that the invention is not to be limited to the particular forms or methods disclosed but to the contrary, the invention is to cover all modifications, equivalents and alternatives falling within the scope of the disclosures and/or claims.

The system can generate an ideal telecom plan for RFP based on the following:

The system accesses the carriers with an RFP listing the total amount of data, SMS and voice predicted for the company over the next several billing cycles or year. The data provided would be a list of lines with a list of usage in the categories analyzed above over a time period that may comprise 15-minute increments. This allows various carriers to tailor plans to meet the needs of the company/group.

Many carriers may employ techniques such as pulling out the top users and separating them into unlimited plans and making a pool for the rest. They may further pull out the smallest users and put them on dedicated plans not pool-able to save costs. Still further, they may analyze the telecom traffic patterns over time, to see how much data has been used at what time of the day. Additionally, popular apps may be identified, which may be eligible for some form of sponsored usage. For example, when looking at Facebook usage, there may be some programs between Facebook and the carrier to allow Facebook to sponsor some of the traffic allowing them to offer a free or subsidized plan.

In other instances, providers or carriers may analyze traffic that requires a high degree of Quality of Service (QoS) such as voice or video and cost that higher than block transfers like FTP or other data which may not be time sensitive. In still other instances, providers or carriers may recommend adopting other apps that work better on their network to reduce costs, perhaps even including in the cost of these apps for a specified number of devices.

What is occurring is the reversing of the tables so-to-speak with the carrier and the customers. In these instances, the customer is dictating what custom plans they want from the carrier instead of the carrier trying to ‘sell’ the customer on their predefined plan offerings.

In other cases, the plans proposed may be customized and may suggest a savings that is currently not provided by the carrier. For example, if a 3 GB plan is not offered by a carrier but would be optimal as moving to a 5 GB plan would be unnecessary and too costly, the system could generate a request for a ‘custom plan’ from the carrier, which may lead to a customized plan offering or a reduction in costs for the 5 GB plan to accommodate the request. Again, the carrier is not in a position of being unable to offer what would work best and may see the upside of negotiating around this issue.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A telecom optimization tool comprising:
a computer having a storage and connected to a network;
a software application executing on said computer, said software application in communication with a plurality of user devices coupled to a mobile device network and measuring voice, data and SMS usage for each user device;
said software application saving the measured voice, data and SMS usage for each user device on the storage to generate historical usage data for each user device;
said software application monitoring apps that are accessed and installed on each user device and generating app data that is saved on the storage;
said software application monitoring app usage on each mobile device and generating app usage data that is saved on the storage;
said software application predicting future voice, data and SMS usage for each mobile device based on the historical usage data, the app data and the app usage data;
said software application comprising a robotic process automation (RPA) bot in communication with a plurality of telecom provider computers, said RPA bot obtaining telecom plan data relating to telecom plans offered by the plurality of telecom providers; and
said software application analyzing the gathered telecom plan data and automatically adjusting a telecom plan associated with at least one of the user devices based on the predicted voice, data and SMS usage for the at least one user device.

2. The telecom optimization tool according to claim 1, further comprising third-party app usage data saved on said storage, said software application using the third-party app usage data in generating the predicted voice, data and SMS usage for the at least one user device.

3. The telecom optimization tool according to claim 2, wherein when an app that is installed on the at least one of the mobile device and the app comprises a messaging app, said software automatically extrapolates a reduction in SMS usage based on third-party app usage data associated with the messaging app.

4. The telecom optimization tool according to claim 2, wherein when an app that is installed on the at least one of the mobile device and the app comprises a video conferencing app, said software automatically extrapolates a reduction in voice usage based on third-party app usage data associated with the video conferencing app.

5. The telecom optimization tool according to claim 1, wherein the network comprises a Wi-Fi network.

6. The telecom optimization tool according to claim 5, wherein the historical usage data includes information relating to a duration for which the at least one of the user device is connected to the Wi-Fi network on a recurring basis.

7. The telecom optimization tool according to claim 1, wherein the at least one user device is associated with a group of user devices having a common telecom plan and said software application automatically modifying the common telecom plan based on the predicted voice, data and SMS usage for user devices in the group.

8. The telecom optimization tool according to claim 7, wherein said group of user devices comprises a first group and said common telecom plan comprises a first telecom plan, further including a second group of user devices having a second common telecom plan associated with the second group, said software application automatically modifying the second common telecom plan based on the predicted voice, data and SMS usage for user devices associated with the second group.

9. The telecom optimization tool according to claim 8, wherein the first telecom plan is different from the second telecom plan.

10. The telecom optimization tool according to claim 9, wherein the first telecom plan is provided by a first telecom provider from the second telecom plan is provided by a second telecom provider, where the first telecom provider is different than the second telecom provider.

11. The telecom optimization tool according to claim 10, wherein said software application automatically moves the at least one user device from the first group to the second group based on the predicted voice, data and SMS usage for the at least one user device.

12. The telecom optimization tool according to claim 10, wherein said software application automatically moves the at least one user device from the first group to the second group further based on predicted voice, data and SMS usage for all the user devices associated with the first group and all the user devices associated with the second group.

13. The telecom optimization tool according to claim 7, wherein said group of user devices comprises a first group and said common telecom plan comprises a first telecom plan, further including a second group of user devices having a second common telecom plan associated with the second group, said software application automatically moving the at least one user device from the first common telecom plan to the second common telecom plan based on the predicted voice, data and SMS usage for the at least one user device and based on a predicted voice, data and SMS usage for user devices associated with the second group.

14. The telecom optimization tool according to claim 1, wherein the gathered telecom plan data gathered by the RPA bot from the plurality of telecom provider computers is inserted into a table of telecom plan data that lists the plans by attribute for comparison by attribute.

15. The telecom optimization tool according to claim 14, wherein the table lists the attributes in rows for direct comparison of attributes from plan to plan.

16. The telecom optimization tool according to claim 14, wherein each attribute is assigned a weight relative to the other attributes.

17. The telecom optimization tool according to claim 16, wherein cost and overage charges for each plan is assigned the highest weight.

18. The telecom optimization tool according to claim 17, wherein said software application maps predicted usage for the at least mobile device to each of the plan attributes and extrapolates cost for each plan over multiple billing cycles, wherein the software application automatically adjusts which telecom plan is associated with the at least one mobile device when a cost savings is predicted within a predefined threshold time period.

19. A telecom optimization tool comprising:
a computer having a storage and connected to a network;
a software application executing on said computer, said software application in communication with a plurality of user devices coupled to a mobile device network and measuring voice, data and SMS usage for each user device associated with a current telecom plan provided by a current telecom provider;
said software application saving the measured voice, data and SMS usage for each user device on the storage to generate historical usage data for each user device;
said software application monitoring apps that are accessed and installed on each user device and generating app data that is saved on the storage;
said software application monitoring app usage on each mobile device and generating app usage data that is saved on the storage;
said software application predicting future voice, data and SMS usage for each mobile device based on the historical usage data, the app data and the app usage data;
said software application generating a Request For Proposal (RFP) based on the predicted future voice, data and SMS usage for each mobile device, the RFP automatically posted to an online marketplace by said software application where the online marketplace is accessible by a plurality of telecom provider computers;
said software application receiving telecom plan data relating to telecom plans offered by the plurality of telecom providers in response to the RFP; and
said software application analyzing the gathered telecom plan data and automatically adjusting at least one telecom plan associated with the plurality of user devices based on the received telecom plan data.

20. The telecom optimization tool according to claim 18, wherein the software application analyzes the received telecom plan data associated with the plurality of telecom providers and automatically generates a modified RFP that is sent to one of the plurality of telecom providers based on the received telecom plan data received from the first telecom provider.

21. The telecom optimization tool according to claim 20, wherein the software receives a customized telecom plan that is generated by the telecom provider that received the modified RFP, said software automatically moving the plurality of user devices to the customized telecom plan.

22. The telecom optimization tool according to claim 20, wherein the telecom provider that generated the customized telecom plan is different than the current telecom provider.
